(19) United States
(12) Patent Application Publication
(10) Pub. No.: US 2003/0138265 A1
(43) Pub. Date: Jul. 24, 2003

(54) Apparatus and method for protecting surfaces within an image forming device

(76) Inventor: Roman T. Wachter, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/056,952

(22) Filed: Jan. 24, 2002

(51) Int. Cl. G03G 21/00

(52) U.S. Cl. 399/98; 399/99

(57) ABSTRACT

A vacuum system for an image forming device is disclosed. The vacuum system collects airborne particles generated within the image forming device and thereby prevents airborne particles from depositing onto certain surfaces, such as optical surfaces, located within the image forming device.

### FIELD OF THE INVENTION

The present invention relates generally to protecting surfaces within an image forming device and more particularly to the use of a vacuum system to remove airborne particles from the inside of an image forming device.

### BACKGROUND OF THE INVENTION

Laser printers typically include an electrophotographic (EP) drum, a paper feed system and an optics system for directing a laser beam onto the EP drum. The paper feed system may include various optic sensors that sense the position of paper in the feed system. The optics system may include various optical elements (e.g., a laser source, mirrors and lenses).

During the operation of a laser printer, particles (such as paper fibers and toner particles) can become airborne. These airborne particles can deposit onto various surfaces within the printer resulting in a degradation of printer reliability or degradation of print quality or both. For example, airborne particles may deposit onto the optic sensors in the printer. As a result, the reliability of the sensors is decreased. Additionally, airborne particles may deposit on the optical surfaces (i.e., the reflecting surface of a mirror or the refractive surface of a lens) in the optical system. As a result, print quality can be degraded.

There are several prior art solutions to solve this problem. Each one of these solutions, however, has disadvantages. For example, air baffles can be used to reduce or eliminate the flow of air through the printer. Unfortunately, reducing or eliminating air flow can result in increased temperatures in the printer. The increased temperatures can reduce the life of the printer electronics and can cause other reliability problems. A second solution is to instruct the user to clean various surfaces within the printer on a periodic basis. This solution is obviously inconvenient to the user and can result in customer dissatisfaction and loss of customer productivity. A third solution is to require a service representative to make periodic visits to the customers location in order to clean the customer's printer. This solution is, of course, expensive and time consuming.

### SUMMARY OF THE INVENTION

In one embodiment, an image forming device is provided. The image forming device includes an enclosure. Disposed within the enclosure is a printing mechanism and a vacuum system. The vacuum system includes a receptacle for receiving and holding particles. The vacuum system is capable of generating a vacuum within the enclosure so as to direct airborne particles present within the disclosure into the receptacle.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high level block diagram of a printer according to one example embodiment of the invention;

FIG. 2 provides a cross sectional view of a vacuum system; and

FIG. 3 shows how the vacuum system may be positioned in the printer

### DETAILED DESCRIPTION OF THE INVENTION

In the following detailed description and in the several figures of the drawings, like elements are identified with like reference numerals.

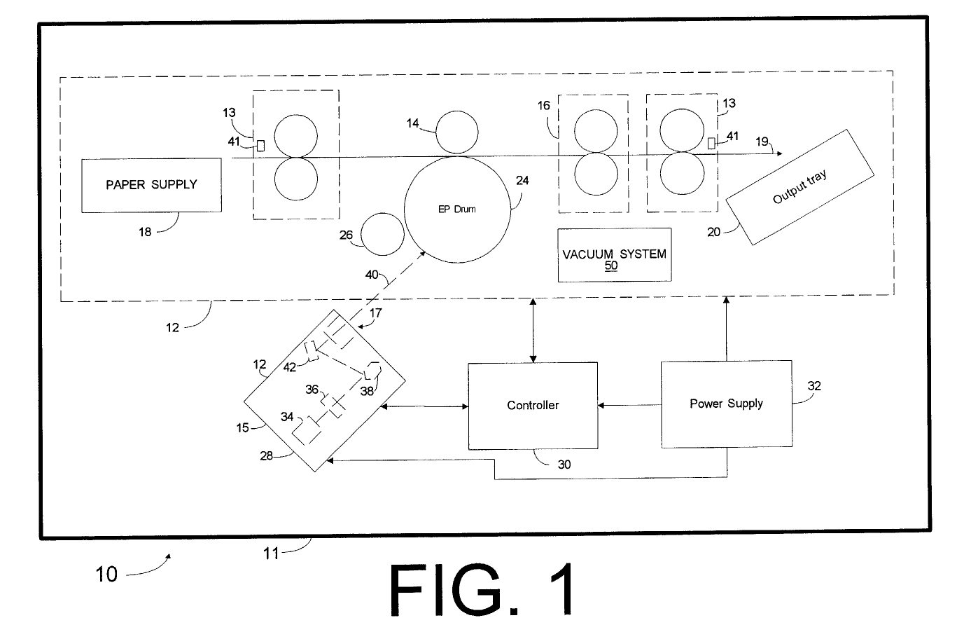

FIG. 1 is a high level block diagram of a printer 10 that is in accordance with one embodiment of the invention. The printer 10 may represent any printing device that makes use of an electrophotographic (EP) process to print a page. For example, the printer 10 may be a monochrome or a color laser printer. In addition, the printer 10 may allow a user to generate copies or to print over a communication link (e.g., a network), or both. Thus, for example, the printer 10 may include a scanner mechanism for scanning documents and/or a network connection for receiving a print job from a host computer over a network.

As shown in FIG. 1, the printer 10 generally includes an enclosure 11. Disposed within the enclosure 11 is a printing mechanism 12, a control and image processing system (controller) 30 and a power supply 32. The Controller 30 controls the operation of the printing mechanism 12 and provides the printer 10 with the ability to receive and to process a print job from, for example, an external host computer or a local scanner mechanism. The Power supply 32 provides power to the controller 30 and to various components in the printing mechanism 12.

The Printing mechanism 12 may include various standard components such as a paper supply 18, a paper feed system 13 (e.g., rollers, jam detectors, etc.), an EP drum 24, a toner station 26, a transfer station 14, a fusing station 16, and a paper output tray 20. The page feed system 13 includes various optical sensors 41. The optical sensors 41 are used to sense the position of the paper in the paper feed system 13 and to provide this information to the controller 30.

In addition, the printing mechanism 12 includes an optics system 28. As shown, the optics system 28 includes a number of optical components located within an enclosure 15. The optics system 28 is used to generate a laser beam 40 and to direct the laser beam 40 through an aperture (exit window 17) in the enclosure 15 onto the EP drum 24. The optical components may include, for example, a laser beam source 34, a lens 36, a polygon mirror 38 and an exit mirror 42.

During a printing operation, the page feed system 13 operates to feed a page from the paper supply 18 along a paper path 19. The optics system 28 operates in a standard manner to direct the laser beam appropriately onto the EP drum 24 so as to generate a latent image consisting of positive charges. At the developing station 26, negatively charged toner particles are applied to the EP drum 24. The toner particles are attracted to the positive charges on the drum so as to form a toner image. At the transfer station 14, the toner image on the EP drum 24 is transferred to the page. At the fusing station 16, the toner is melted and fused onto the page. The resulting printed page is then transported to the output tray 20.

During the printing operation just described, airborne particles can be generated. These particles can be paper particles, toner particles or both. As indicated above, it is disadvantageous for these particles to deposit onto some of the surfaces in the printer 10.

For example, it is disadvantageous for toner/paper particles to deposit onto the optical sensors 41 as this can reduce the reliability of these sensors. Additionally, it is disadvantageous for the particles to enter the enclosure 15 as the particles may deposit onto the optical surfaces that are part of the optic system 28. Particle deposits on these optical surfaces can result in decreasing image quality.

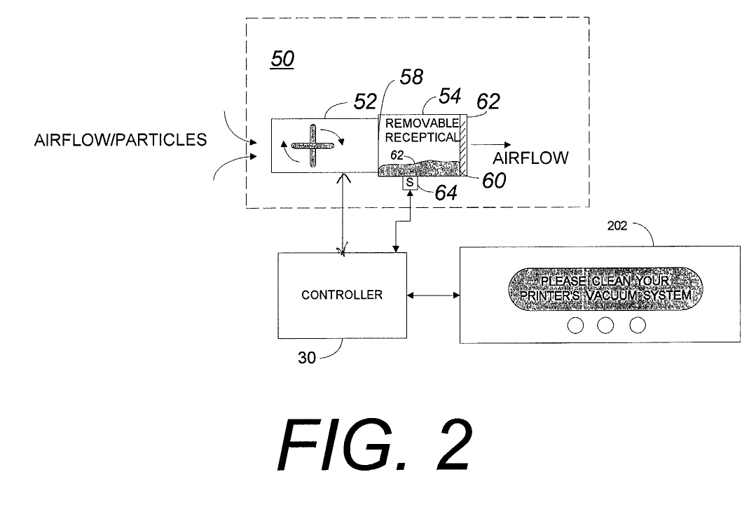

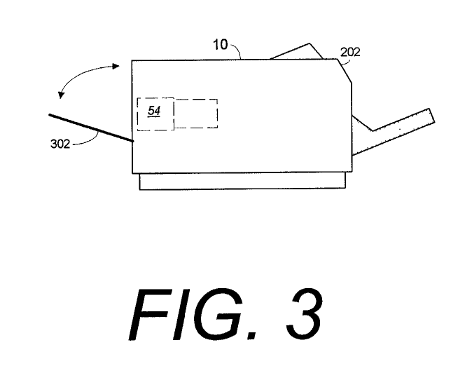

In accordance with this embodiment of the invention, the printer 10 includes an internal vacuum system 50 (depicted in FIG. 2) that is operative to generate a vacuum within the enclosure 11. As will be shown, the vacuum system 50 can remove airborne particles from the inside of the printer 10. To describe the components and operation of the vacuum system 50, reference is made to FIG. 2 and FIG. 3.

FIG. 2 provides a cross sectional view of the vacuum system 50. As shown, the vacuum system 50 includes a vacuum generator 52 and a receptacle 54. The receptacle 54 is coupled to the vacuum generator 52 and configured so that when the vacuum generator 52 generates a vacuum, the resulting airflow is directed into the receptacle 54 at a first entrance (entrance end 58) and out through a second end (exit end) 60. A filter 62 covers the exit end 60 so as to prevent airborne particles that enter the entrance end 58 from leaving the receptacle 54. This results in airborne particles, which enter through the entrance end 58, being collected within the receptacle 54. FIG. 2 depicts the receptacle 54 with a collection of particles 62 captured within the receptacle 54.

In this embodiment, the receptacle 54 is adapted to be easily removed from the vacuum system 50, as well as the printer 10, without the use of a tool. This allow the user to easily remove the receptacle 54 and to clean/replace it on a periodic basis.

FIG. 3 shows the vacuum system 50 disposed in the printer 10 according to one specific implementation. In this example, the printer 10 includes an access door 302 having an open position and a closed position. The access door 302 is shown in an open position. The vacuum system 50 is positioned so that the user of the printer 10 can open the access door 302 and easily remove the receptacle 54 without the use of a tool. Once the receptacle is removed, the user can then clean or replace the receptacle 54.

Referring again to FIG. 2, the vacuum system 50 is controlled by the controller 30. In general, the controller 30 operates to turn the vacuum system 50 ON or OFF. In this embodiment, for example, the controller 30 is configured to turn the vacuum system 50 ON when the printer 10 is generating airborne particles at a relatively high rate.

For example, in some implementations, the controller 30 may be configured to turn the vacuum system 50 ON when the printer 10 is performing a printing operation. In other embodiments, the controller 30 may turn the vacuum system 50 ON only when the printer 10 is performing some particular function during a printing operation. For example, the controller 30 may be configured to turn the vacuum system 50 ON when paper is moving through the page feed system 13 and/or toner particles are being applied to the EP drum 24.

In addition to turning the vacuum system 50 ON or OFF, the controller 30 may also be configured to notify the user when the vacuum system 50 should be cleaned. For example, in the present embodiment, the vacuum system 50 includes a sensor 64. The sensor 64 can sense when the receptacle 54 should be cleaned and provides this information to the controller 30.

The controller 30 can be configured to respond to the signal from the sensor 64 by informing the user that the receptacle 54 should be cleaned or replaced. In this embodiment, for example, the controller 30 informs the user of this condition by causing a local display panel 202 of the printer 10 to display a message that the receptacle 54 should be cleaned.

From the forgoing, it will be appreciated that the present invention provides an improved apparatus for preventing airborne particles from depositing onto certain internal surfaces, such as optical surfaces, in a printer. As a result, this invention can be used to increase printer reliability as well as prevent degradation of print quality.

It should be understood that the foregoing description is only illustrative of the invention. For example, the present invention has so far been described for use in a laser printer. It is contemplated, however, that the present invention may be useful in other types of printers and in other types of image forming devices. For example, the present invention can be used in inkjet printers, CRT display devices or LCD display devices. Thus, various alternatives and modifications can be devised by those skilled in the art without departing from the invention. Accordingly, the present invention is intended to embrace all such alternatives, modifications and variances that fall within the scope of the appended claims.

What is claimed is:

1. An image forming apparatus, comprising:
(a) an enclosure;
(b) a printing mechanism disposed within the enclosure;
(c) a vacuum system disposed within the enclosure; and
wherein the vacuum system includes a receptacle for receiving and holding particles; and
wherein the vacuum system is capable of generating a vacuum within the enclosure so as to direct airborne particles present within the disclosure into the receptacle.

2. The image forming apparatus of claim 1, wherein the image forming apparatus is a laser printer.

3. The image forming apparatus of claim 2, further comprising:
(d) a control system for controlling the printing mechanism during a printing operation and for controlling the operation of the vacuum system; and
wherein the control system causes the vacuum system to generate the vacuum during the printing operation.

4. The image forming apparatus of claim 3, wherein the enclosure include an access door having an open and a closed position; and wherein the vacuum system is positioned within the enclosure so that the receptacle for receiving the particles is exposed when the access door is in an open position.

5. The image forming apparatus of claim 4, wherein the receptacle is adapted to be easily removable from the image forming apparatus when the access door is in an open position.

6. The image forming apparatus of claim 1, wherein the receptacle is easily removable from the vacuum system.

7. A method of preventing particles from depositing onto certain surfaces within a printer, comprising:
(a) providing, within the printer, a receptacle for receiving and holding particles; and
(b) generating, within the printer, a vacuum that directs airborne particles generated within the printer into the receptacle.

8. The method of claim 7, wherein step (b) is performed only when the printer is performing a printing operation.

9. The method of claim 8, wherein the printer is a laser printer.

10. The method of claim 7, wherein the receptacle is adapted to be easily removable from the printer.

11. An image forming apparatus, comprising:
(a) means for printing an image;
(b) a receptacle for trapping particles;
(c) means for generating a vacuum within the image forming apparatus that directs airborne particles generated within the apparatus into the receptacle.

12. The apparatus of claim 1, wherein said image forming apparatus is a laser printer.

13. The image forming apparatus of claim 11, wherein the vacuum generating means generates the vacuum only when the printing means is printing the image.

14. The image forming apparatus of claim 11, wherein the receptacle is easily removable from the image forming apparatus.

15. The image forming apparatus of the claim 11, further comprising:
(d) means for informing a user when the receptacle should be cleaned
